(19) United States
(12) Patent Application Publication
(10) Pub. No.: US 2025/0303583 A1
(43) Pub. Date: Oct. 2, 2025

(54) Assembly Structure and Station for Assembling and Disassembling the Same

(71) Applicants: Hyundai Motor Company, Seoul (KR); Kia Corporation, Seoul (KR)

(72) Inventors: Beom Su Kim, Yongin-Si (KR); Hyun Seop Lim, Anyang-Si (KR); Dong Hyun Lee, Ansan-Si (KR); Dong Jin Hyun, Suwon-Si (KR); Ju Young Yoon, Suwon-Si (KR)

(21) Appl. No.: 18/777,369

(22) Filed: Jul. 18, 2024

(30) Foreign Application Priority Data
Mar. 26, 2024 (KR) 10-2024-0041286

(51) Int. Cl. B25J 15/04

(52) U.S. Cl. CPC B25J 15/0433

(57) ABSTRACT

A station may include a station base part fixed to one side of a station body part and having an assembling part seating region having a shape recessed inward, and a station holder part having a shape protruding upward from the station base part, in which an inner surface of the station holder part includes a first holder part surface region having a shape curved in a direction intersecting an upward/downward direction, and second holder part surface regions each connected to one side end of the first holder part surface region and having a curvature different from a curvature of the first holder part surface region. The station may be configured to reversibly assemble an assembly structure.

### CROSS-REFERENCE TO RELATED APPLICATION

This application claims priority to and the benefit of Korean Patent Application No. 10-2024-0041286 filed in the Korean Intellectual Property Office on Mar. 26, 2024, the entire contents of which are incorporated herein by reference.

### TECHNICAL FIELD

The present disclosure relates to an assembly structure and a station for assembling and disassembling the same, and more particularly, to an assembly structure, which is capable of being applied to easily couple and uncouple a robot arm and a gripper configured to be coupled to an end of the robot arm, and a station capable of assembling and disassembling the assembly structure.

### BACKGROUND

Methods of coupling a gripper (or other tool/functional element) configured to perform a gripping function, to a robot arm provided on a robot are broadly classified into i) a first method of assembling the gripper directly to the robot arm by using a bolt member or the like, and ii) a second method of using a separate component configured to connect the gripper and the robot arm. Among the methods, i) the first method is performed by separating the gripper, which is intended to be replaced, from the robot arm by loosening a member such as a bolt, bringing another gripper into close contact with the robot arm, and then fastening the bolt. In addition, ii) the second method is performed by connecting the gripper and the robot arm by using a quick-changer-type coupling member.

However, in the related art, i) the first method has a problem in that a large amount of time is required to detach and reattach the gripper, and the first method is inconvenient to use. In addition, ii) the second method has a problem in that the type of connector, which may be adopted to electrically connect the gripper and the robot arm, is limited in accordance with a structure and operational principle of the coupling member. For example, a method of coupling the gripper and the robot arm by rotating the coupling member has a problem in that a plug-socket type connector structure cannot be applied.

### SUMMARY

The following summary presents a simplified summary of certain features. The summary is not an extensive overview and is not intended to identify key or critical elements.

Systems, apparatuses, and methods are described for an assembly structure and station for assembling and disassembling the same. An assembly structure may comprise an assembling part; and a coupling part configured to be attachable to or detachable from the assembling part. The assembling part may comprise a body comprising a first side that forms a first opening; and a flange fixedly coupled to a first side of the body. The coupling part may comprise a base; and a sleeve configured to surround a periphery of the base and comprising a second side that forms a second opening. The flange may be configured to penetrate the sleeve, in a direction facing the base, such that a rotational mobility, about a rotation center axis of the assembly structure, of the flange is restricted relative to a rotational mobility of the base about the rotation center axis. The sleeve may be configured to be rotatable relative to the base. The sleeve and the flange may be configured to, based on a rotation angle of the sleeve with respect to the base being within a predetermined range, interfere with each other in an longitudinal direction parallel to the rotation center axis. An outer surface of the sleeve, in a radial direction perpendicular to the rotation center axis, may comprises a first sleeve surface region having a first curvature relative to the rotation center axis; and a second sleeve surface region connected to the first sleeve surface region in a circumferential direction around the rotation center axis and having a second curvature, relative to the rotation center axis, different from the first curvature.

### BRIEF DESCRIPTION OF THE DRAWINGS

FIG. 1 is a view illustrating a structure of a robot according to the present disclosure.

FIG. 2 is a view illustrating a state made before an assembling part and a coupling part of an assembly structure according to the present disclosure are coupled when viewed from above.

FIG. 3 is a view illustrating a state made before the assembling part and the coupling part of the assembly structure according to the present disclosure are coupled when viewed from below.

FIG. 4 is an exploded perspective view of the assembly structure according to the present disclosure.

FIG. 5 is an enlarged view of a base member of the coupling part provided in the assembly structure according to the present disclosure.

FIG. 6 is an enlarged view of an upper sleeve of the coupling part provided in the assembly structure according to the present disclosure.

FIG. 7 is an enlarged view of a lower sleeve of the coupling part provided in the assembly structure according to the present disclosure.

FIG. 8 is a view illustrating a structure of a horizontal cross-section of the coupling part according to the present disclosure and illustrating a state in which a sleeve member is fixedly coupled to the base member by a latch member.

FIG. 9 is a view illustrating the structure of the horizontal cross-section of the coupling part according to the present disclosure and illustrating a state in which the sleeve member and the base member are uncoupled.

FIG. 10 is a vertical cross-sectional view illustrating the coupling part according to the present disclosure and illustrating a state made before the sleeve member is moved upward by bolt-nut coupling between a bolt member and a sliding member.

FIG. 11 is a vertical cross-sectional view illustrating the coupling part according to the present disclosure and illustrating a state made after the sleeve member is moved upward by bolt-nut coupling between the bolt member and the sliding member.

FIG. 12 is a vertical cross-sectional view illustrating the assembly structure according to the present disclosure and illustrating a state made after the assembling part and the coupling part are completely coupled.

FIG. 13 is a perspective view of a station according to the present disclosure.

FIG. 14 is an enlarged cross-sectional view illustrating a first holder part surface region formed on a station holder part of the station according to the present disclosure.

FIG. 15 is an enlarged cross-sectional view illustrating an assembling part seating region of a station base part of the station and peripheral components thereof according to the present disclosure.

FIG. 16 is a top plan view illustrating another example of the station base part of the station according to the present disclosure.

FIG. 17 is a view illustrating a state in which a robot arm including the coupling part enters the station in a state in which a gripper including the assembling part is seated on the station according to the present disclosure.

FIG. 18 is a cross-sectional view illustrating a state of an interior of the coupling part when the coupling part enters the station in FIG. 17.

FIG. 19 is a cross-sectional view illustrating a state of the assembling part seated on the station in FIG. 17.

FIG. 20 is a view illustrating a state in which the robot arm is rotated so that the coupling part is in a state of being capable of being coupled to the gripper after the coupling part enters the station according to the present disclosure.

FIG. 21 is a cross-sectional view illustrating a state of the interior of the coupling part when the robot arm is rotated in FIG. 20.

FIG. 22 is a view illustrating a state in which the robot arm is moved downward and the coupling part is coupled to the assembling part in the station according to the present disclosure.

FIG. 23 is a view illustrating a state in which the coupling part and the assembling part are spaced apart from each other before the robot arm is moved downward in FIG. 22.

FIG. 24 is a view illustrating a state in which the robot arm is moved downward in FIG. 22 and the coupling part and the assembling part are coupled to each other.

FIG. 25 is a view illustrating a state in which the robot arm rotates in a state in which the coupling part and the assembling part are coupled to each other in the station according to the present disclosure.

FIG. 26 is a cross-sectional view illustrating a state of the assembling part seated on the station in FIG. 25.

FIG. 27 is a view illustrating a state in which the robot arm and the gripper are separated from the station.

### DETAILED DESCRIPTION

Hereinafter, a robot and an assembly structure according to the present disclosure will be described with reference to the drawings.

In describing examples of the present disclosure, well-known functions or structures have not been described in detail, since a detailed description thereof may unnecessarily obscure the gist of the present disclosure. The same constituent elements in the drawings are denoted by the same reference numerals and a repeated or duplicative description of the same elements has been omitted.

In the present disclosure, if an element is simply referred to as being “connected to”, “coupled to” or “linked to” another element, this may mean that an element is “directly connected to”, “directly coupled to”, or “directly linked to” another element or this may mean that an element is connected to, coupled to, or linked to another element with another element intervening therebetween. In addition, if a first element “includes”, “comprises” or “has” another element, the first element may further include still other elements unless specifically stated otherwise.

In the present disclosure, the terms first, second, etc. are only used to distinguish one element from another and do not limit the order or the degree of importance between the elements unless specifically stated otherwise. Accordingly, a first element in an example could be termed a second element in another example, and, similarly, a second element in an example could be termed a first element in another example, without departing from the scope of the present disclosure.

In the present disclosure, elements are distinguished from each other for clearly describing each feature, but this does not necessarily mean that the elements are separated. In other words, a plurality of elements may be integrated in one hardware or software unit, or one element may be distributed and formed in a plurality of hardware or software units.

Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. Examples including other elements in addition to the elements described in the various examples are also included in the scope of the present disclosure.

The advantages and features of the present disclosure and the ways of attaining them should become apparent to those of ordinary skill in the art with reference to examples of the present disclosure described below in detail in conjunction with the accompanying drawings. The examples of the present disclosure, however, may be embodied in many different forms and should not be constructed as being limited to the example examples set forth herein. Rather, the examples described herein are provided to make this disclosure more complete and to fully convey the scope of the present disclosure to those having ordinary skill in the art to which the present disclosure pertains.

In the present disclosure, each of phrases such as “A or B”, “at least one of A and B”, “at least one of A or B”, “A, B or C”, “at least one of A, B and C”, and each of the phrases such as “at least one of A, B or C” and “at least one of A, B, C or combination thereof” may include any one or all possible combinations of the items listed together in the corresponding one of the phrases.

In the present disclosure, expressions of location relations used in the present specification such as “upper”, “lower”, etc., are employed for the convenience of explanation. If drawings illustrated in the present specification are inversed or rotated, the location relations described in the specification may be inversely or rotatedly understood.

If a component, device, element, or the like of the present disclosure is described as having a purpose or performing an operation, function, or the like, the component, device, or element should be considered herein as being “configured to” meet that purpose or perform that operation or function.

### Robot and Assembly Structure

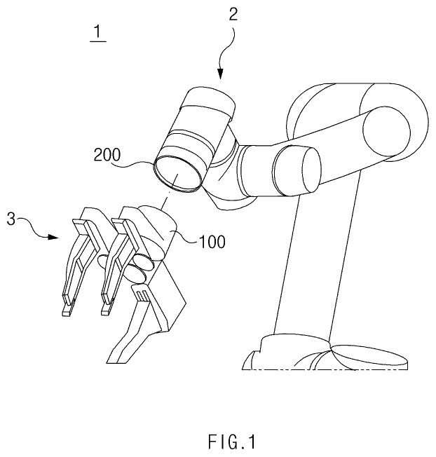

FIG. 1 is a view illustrating a structure of a robot according to the present disclosure.

With reference to FIG. 1, a robot 1 according to the present disclosure may include a robot arm 2 and a gripper 3 configured to be coupled to the robot arm 2. That is, the gripper 3 may be configured to be coupled to one side of the robot arm 2 and perform a gripping function for gripping an object.

The robot 1 may include an assembly structure 10 capable of attaching and detaching the robot arm 2 and the gripper 3. In particular, as described herein, the assembly structure 10 may more easily detach and attach the robot arm 2 and the gripper 3 and prevent the robot arm 2 and the gripper 3 from being unintentionally uncoupled by an external force. Hereinafter, the structure of the assembly structure 10 will be described in detail with reference to the drawings. However, the assembly structure 10 may not only be applied to attach and detach the robot arm and the gripper, but also be applied, in the same way, to a structure for coupling two components (e.g., required to be reversibly attached and detached).

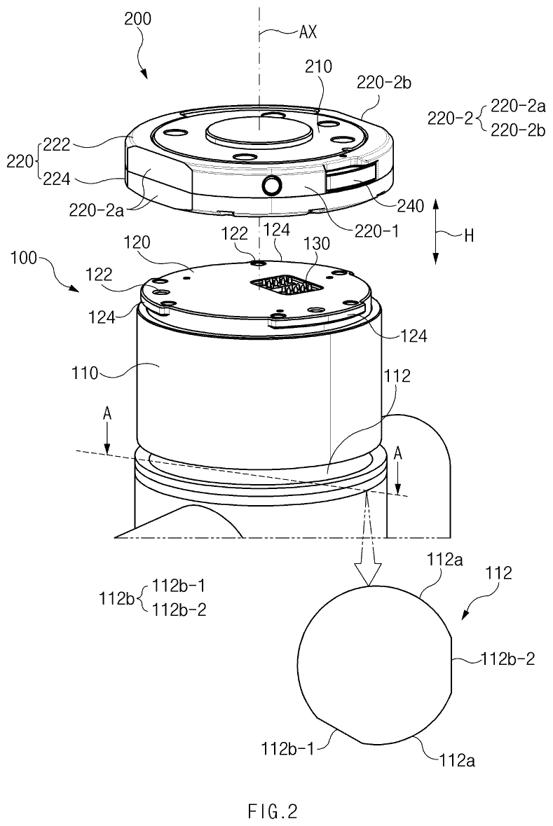

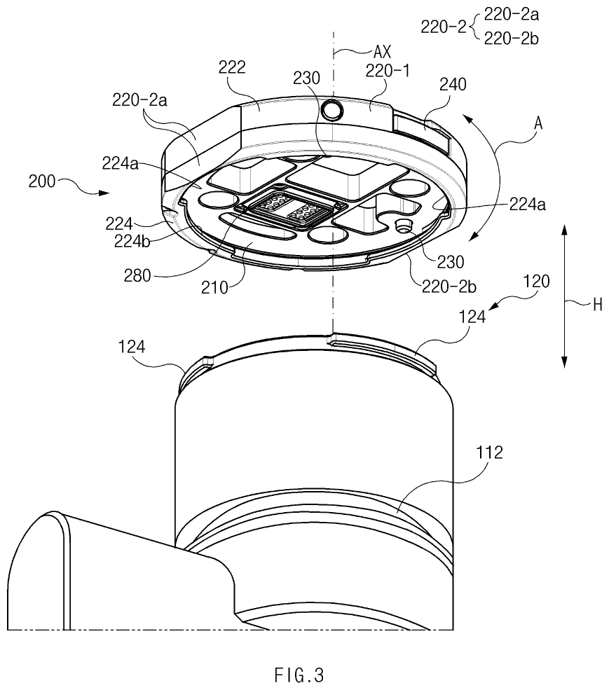

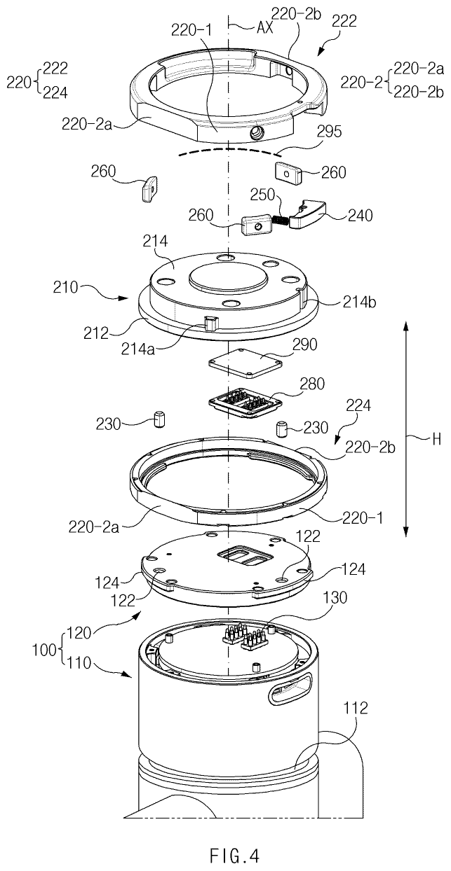

FIG. 2 is a view illustrating a state made before an assembling part and a coupling part of the assembly structure according to the present disclosure are coupled when viewed from above, and FIG. 3 is a view illustrating a state made before the assembling part and the coupling part of the assembly structure according to the present disclosure are coupled when viewed from below. Further, FIG. 4 is an exploded perspective view of the assembly structure according to the present disclosure.

With reference to FIGS. 2 to 4, the assembly structure 10 may include an assembling part 100 and a coupling part 200 provided configured to be attached to and detached from the assembling part 100 (e.g., from above the assembling part 100 in FIGS. 2-4). For example, in case that the assembly structure 10 is applied to the robot, the assembling part 100 may be coupled to the gripper coupled to one side of the robot arm and configured to perform the gripping function, and the coupling part 200 may be coupled to the robot arm provided on the robot. Therefore, the robot arm and the gripper may be assembled to each other by coupling the assembling part 100 and the coupling part 200 of the assembly structure 10. The robot arm and the gripper may also be separated from each other by uncoupling the assembling part 100 and the coupling part 200.

With reference to FIGS. 2 to 4, the assembling part 100 may include a body 110 configured to define a body of the assembling part 100. The body 110 may form a space therein, and opened at a first (e.g., upper) side thereof. The assembling part 100 may also include a flange 120 coupled to an upper portion of the body 110 (e.g., at the opening in the first side of the body 110 and/or at the opened first side of the body 110). For example, the flange 120 may be fixedly coupled to the body 110.

The coupling part 200 may include a base member 210 (e.g., a base) and a sleeve member 220 (e.g., a sleeve) provided to surround a periphery of the base member 210 and opened at a lower side thereof. To couple the assembling part 100 and the coupling part 200, a part of the assembling part 100 may be inserted into the coupling part 200 through a space opened at the second (e.g., lower) side of the sleeve member 220. Hereinafter, for convenience of description, the description will be focused on a case in which the coupling part 200 is provided in a lower region of the assembling part 100. However, during an actual process of using the assembly structure 10, a configuration may be used, as necessary, in which the coupling part 200 is provided in an upper region of the assembling part 100, or the assembling part 100 and the coupling part 200 are matched with each other in a horizontal direction.

With reference to FIGS. 2 to 4, the flange 120 may penetrate the sleeve member 220 and face the base member 210 in an upward/downward direction H of the assembly structure 10. The sleeve member 220 may be configured to be rotatable relative to a base flange 212 and the assembling part 100. When describing relative rotations between the sleeve member 220 and the base flange 212 and between the sleeve member 220 and the assembling part 100 herein, a center of a rotational motion and/or a rotational mobility is referred to as a rotation center axis AX of the assembly structure 10. In case that the assembling part 100 and the coupling part 200 are disposed in parallel with the upward/downward direction H, the rotation center axis AX may also be defined to be parallel to the upward/downward direction H.

If the assembling part 100 and the coupling part 200 are completely coupled, the assembling part 100 and the base member 210 may be coupled so that the assembling part 100 and the base member 210 cannot rotate relative to each other. That is, the flange 120 may penetrate the sleeve member 220 and face a lower surface of the base member 210, and a rotational mobility of the flange 120 about the rotation center axis AX of the assembly structure 10 relative to the base member 210 may be restricted.

With reference to FIGS. 2 to 4, in order to satisfy the condition in which the rotational mobility is restricted, the coupling part 200 may include one or more pin members 230 coupled to the lower surface of the base member 210 and protruding downward from the lower surface of the base member 210. For example, a recessed region may be defined in the lower surface of the base member 210 and have a shape corresponding to a size of the pin member 230, and the pin member 230 may be inserted into the recessed region defined in the lower surface of the base member 210. At least a partial region of the pin member 230 may protrude downward from the base member 210.

A pin insertion groove 122 may be defined in an upper surface of the flange 120 and have a shape recessed downward, such that the pin member 230 may be inserted into the pin insertion groove 122. The size and/or shape of the pin insertion groove 122 may correspond to the size and/or shape of the pin member 230. Therefore, a region of the pin member 230, which protrudes downward from the base member 210, may be inserted into the pin insertion groove 122. The rotational mobility between the base member 210 and the flange 120 may be restricted by interference between the pin member 230 and the flange 120 and interference between the pin member 230 and the base member 210. For example, FIGS. 3 and 4 illustrate that the one or more pin members 230 are provided as two pin members 230.

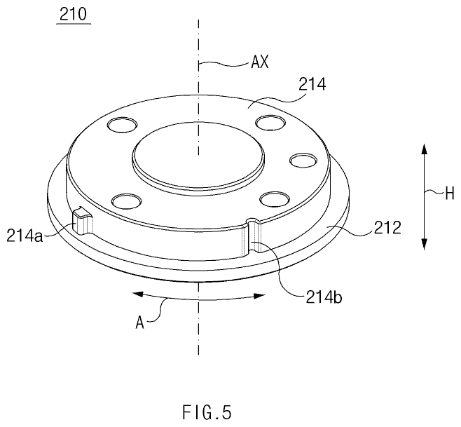

FIG. 5 is an enlarged view of the base member of the coupling part provided in the assembly structure according to the present disclosure.

With reference to FIG. 5, the base member 210 may be divided into a plurality of regions in the upward/downward direction H. For example, the base member 210 may include the base flange 212 having the lower surface to which the pin member 230 (see FIG. 3 and the like) is coupled, and a base protruding portion 214 (e.g., protrusion) protruding upward from the base flange 212. The base flange 212 and the base protruding portion 214 may be distinguished by a relative difference in diameter. That is, as illustrated in FIG. 5, the base flange 212 and the base protruding portion 214 may each have an approximately circular plate shape. In this case, a diameter of the base flange 212 may be larger than a diameter of the base protruding portion 214. However, the configuration in which the base flange 212 and the base protruding portion 214 each have an approximately circular plate does not mean that the two components have perfectly circular plate shapes. For example, the base protruding portion 214 may have an approximately circular plate shape, but may also have components and/or portions that either protrude outward or are recessed inward from an outer peripheral surface of the base protruding portion 214 or the like. A peripheral surface of any component may be understood as a surface, among surfaces of the component, defined in a direction intersecting (more particularly, perpendicularly intersecting) a radial direction perpendicular to the rotation center axis AX of the assembly structure 10, except for upper and lower surfaces of the component. In addition, a direction in which a peripheral surface of any component extends perpendicular to the rotation center axis AX may be defined as a circumferential direction A of the assembly structure 10.

With continued reference to FIG. 5, an interference region 214a may be defined on the outer peripheral surface of the base protruding portion 214 and have a shape protruding outward in the radial direction. The interference region 214a may be configured to limit the rotational motion/mobility of the sleeve member 220 to a predetermined rotation angle range by interfering with the sleeve member 220 in case that the sleeve member 220 is about to deviate from the predetermined rotation angle range and rotate relative to the base protruding portion 214. Hereinafter, a detailed shape of the sleeve member 220 will be described.

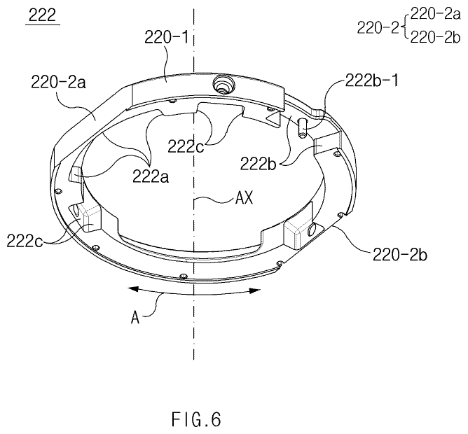

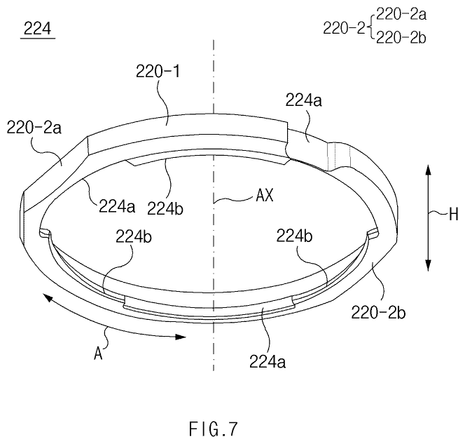

FIG. 6 is an enlarged view of an upper sleeve of the coupling part provided in the assembly structure according to the present disclosure, and FIG. 7 is an enlarged view of a lower sleeve of the coupling part provided in the assembly structure according to the present disclosure.

As illustrated in FIGS. 4, 6, and 7, the sleeve member 220 may be divided into a plurality of components. That is, the sleeve member 220 may include an upper sleeve 222 (e.g., first sleeve) configured to define an upper region of the sleeve member 220 and surround an outer peripheral surface of the base protruding portion 214, and a lower sleeve 224 provided below the upper sleeve 222, configured to surround the outer peripheral surface of the base flange 212, and fixedly coupled to the upper sleeve 222. For example, the upper sleeve 222 and the lower sleeve 224 may be fixedly coupled to each other by bolting.

The upper sleeve 222 may have a rotation interference groove 222a. The rotation interference groove 222a may be defined in an inner peripheral surface of the upper sleeve 222 that is a surface facing the base protruding portion 214. The interference region 214a of the base protruding portion 214 may be accommodated in the rotation interference groove 222a. The relative rotational motion of the base member 210 relative to the sleeve member 220 may be performed within a range in which the interference region 214a and the rotation interference groove 222a do not interfere with each other. That is, the interference region 214a and the rotation interference groove 222a may be configured to allow the sleeve member 220 including the upper sleeve 222 to perform the relative rotational motion within the predetermined rotation angle range without rotating 360 degrees relative to the base member 210. The interference region 214a may be provided to interfere with the upper sleeve 222 at a boundary of the rotation interference groove 222a based on the circumferential direction A. That is, in case that the interference region 214a is about to move in a direction that deviates from the boundary of the rotation interference groove 222a based on the circumferential direction A, the interference region 214a interferes with an inner surface defined at one side end of the rotation interference groove 222a based on the circumferential direction A, such that the relative rotational motion/mobility between the sleeve member 220 and the base member 210 is not performed any further.

With reference to FIGS. 2, 3, and 5, a recessed region 214b may be defined in the outer peripheral surface of the base protruding portion 214 of the assembly structure 10 according to the present disclosure, and the recessed region 214b may be provided to be spaced apart from the interference region 214a in the circumferential direction A and have a shape recessed inward. In addition, the coupling part 200 may further include a latch member 240 (e.g., a latch) rotatably coupled to the upper sleeve 222. In a state in which the sleeve member 220 is coupled to the base member 210 so that the interference region 214a is placed in the rotation interference groove 222a, at least a partial region of the latch member 240 may be inserted into the recessed region 214b. The latch member 240 may be configured to be inserted into the recessed region 214b when the sleeve member 220 is placed at a predetermined rotated position relative to the base member 210, such that interference between the latch member 240 and the recessed region 214b may prevent the sleeve member 220 from rotating any further relative to the base member 210. That is, the latch member 240 may be configured to be inserted into the recessed region 214b to fixedly couple the sleeve member 220 and the base member 210 as long as the interference between the rotation interference groove 222a and the interference region 214a may restrict the range in which the relative rotation between the sleeve member 220 and the base member 210 is allowed. Further, when the latch member 240 is inserted into the recessed region 214b, the assembling part 100 and the coupling part 200 are fixedly coupled to each other.

For example, the latch member 240 may include an insertion region 240a having a shape protruding toward the rotation center axis AX so as to be inserted into the recessed region 214b. The insertion region 240a may have a size and shape corresponding to the recessed region 214b.

With reference to FIGS. 4 and 6, the coupling part 200 of the assembly structure 10 may further include an elastic pressing member 295 (e.g., elastic insert, elastic material, etc.) accommodated in the rotation interference groove 222a and extending in the circumferential direction of the assembly structure 10, i.e., a direction in which the elastic pressing member 295 surrounds the rotation center axis AX.

The elastic pressing member 295 may be configured to press the interference region 214a by being compressed by a change in position of the interference region 214a relative to the rotation interference groove 222a. More specifically, with reference to FIGS. 4 and 6, one side end of the elastic pressing member 295 may be provided to face one side boundary of the rotation interference groove 222a based on the circumferential direction A, and the other side end of the elastic pressing member 295 may be provided to face the interference region 214a. Therefore, when the interference region 214a moves in a direction toward one side boundary of the rotation interference groove 222a based on the circumferential direction A as the base member 210 rotates, the elastic pressing member 295 may be compressed, and the compressed elastic pressing member 295 presses the interference region 214a in a direction opposite to the direction in which the interference region 214a rotates. Therefore, when an external force, which has rotated the base member 210, is eliminated, the base member 210 may be returned, by a pressing force of the elastic pressing member 295, to a state made before the base member 210 has been rotated. Therefore, the elastic pressing member 295 may be configured to allow the assembling part 100 and the coupling part 200 to be more securely and fixedly coupled to each other when the latch member 240 is inserted into the recessed region 214b.

With reference to FIGS. 2 to 4, an outer surface of the sleeve member 220 provided in the assembly structure 10 may be divided into a plurality of regions depending on the shape thereof.

More specifically, the outer surface of the sleeve member 220 based on a radial direction perpendicular to the rotation center axis AX may include first sleeve surface regions 220-1 each having a curved shape that surrounds the rotation center axis AX (e.g., a first curvature relative to or towards the rotation center axis), and one or more second sleeve surface regions 220-2 each connected to (e.g., connected between and/or to one side end of) the first sleeve surface region 220-1 and having a second curvature different from the first curvature of the first sleeve surface region 220-1. For example, as illustrated in FIGS. 2 to 4, the first sleeve surface regions 220-1 and the second sleeve surface regions 220-2 may be formed on the upper sleeve 222 and the lower sleeve 224.

More particularly, a radially outer portion of a cross-sectional shape, which is made by cutting the first sleeve surface region 220-1 in a direction perpendicular to the rotation center axis AX, may have a circumferential shape, and a radially outer portion of a cross-sectional shape, which is made by cutting the second sleeve surface region 220-2 in the direction perpendicular to the rotation center axis AX, may have a line segment shape. This configuration may be understood as a configuration in which the first sleeve surface region 220-1 has a shape of a part of a cylinder, whereas the second sleeve surface region 220-2 has a planar shape.

As described below, the second sleeve surface region 220-2 may be configured to prevent the sleeve member 220 from rotating when the base member 210 rotates during the process in which a station couples and uncouples the assembling part 100 and the coupling part 200. Therefore, during the process of coupling and uncoupling the assembling part 100 and the coupling part 200, the first sleeve surface region 220-1 and the second sleeve surface region 220-2 may be respectively in close contact with a first holder part surface region 352 and a second holder part surface region 354 of the station that will be described below.

The second sleeve surface region 220-2 may be provided as a plurality of second sleeve surface regions 220-2. More specifically, the second sleeve surface regions 220-2 may include a second-first sleeve surface region 220-2a and a second-second sleeve surface region 220-2b provided to be spaced apart from each other in the circumferential direction of the first sleeve surface region with the first sleeve surface region 220-1 interposed therebetween. More specifically, the second-first sleeve surface region 220-2a and the second-second sleeve surface region 220-2b may be provided in parallel with each other. The second-first sleeve surface region 220-2a and the second-second sleeve surface region 220-2b may be shaped to be symmetric with respect to the rotation center axis AX.

With reference to FIGS. 5 and 6, the upper sleeve 222 may have a latch accommodation groove 222b configured to accommodate the latch member 240 and having a shape recessed in the upward/downward direction H (e.g., a longitudinal direction parallel to the rotation center axis AX). That is, the latch accommodation groove 222b may be configured to define an internal space for accommodating the latch member 240. For example, FIG. 6 illustrates a state in which the latch accommodation groove 222b has a shape opened downward. The latch accommodation groove 222b may have a latch rotation shaft 222b-1 configured to penetrate the latch member 240. The latch rotation shaft 222b-1 may serve as a rotation center axis of the latch member 240. For example, FIG. 6 illustrates a state in which the latch rotation shaft 222b-1 protrudes downward from an upper surface of the latch accommodation groove 222b.

With reference to FIGS. 2 to 4, the body 110 of the assembling part 100 may have an approximately cylindrical shape, and a partial region of the body 110 of the assembling part 100 may include a concavely recessed region.

More specifically, the body 110 may include a guide groove region 112 formed in an outer surface of the body 110 based on the radial direction perpendicular to the rotation center axis AX, and the guide groove region 112 may have a shape extending in the circumferential direction A and recessed radially inward. In this case, an outer surface of the guide groove region 112 may be divided into a plurality of regions depending on the shape thereof.

More specifically, the outer surface of the guide groove region 112 based on the radial direction may include first guide groove surface regions 112a each having a curved shape that surrounds the rotation center axis AX, and second guide groove surface regions 112b each connected to one side end of the first guide groove surface region 112a and having a curvature different from a curvature of the first guide groove surface region 112a.

More particularly, a radially outer portion of a cross-sectional shape, which is made by cutting the first guide groove surface region 112a in the direction perpendicular to the rotation center axis AX, may have a circumferential shape, and a radially outer portion having a cross-sectional shape, which is made by cutting the second guide groove surface region 112b in the direction perpendicular to the rotation center axis AX, may have a line segment shape. This configuration may be understood as a configuration in which the first guide groove surface region 112a has a shape of a part of a cylinder, whereas the second guide groove surface region 112b has a planar shape.

As described below, the second guide groove surface region 112b may be a region that is seated on an assembling part seating region of a station base part during the process in which the station couples and uncouples the assembling part 100 and the coupling part 200. More specifically, the second guide groove surface region 112b may be provided to face a movement block member of the station base part to be described below.

The second guide groove surface region 112b may be provided as a plurality of second guide groove surface regions 112b. More specifically, the second guide groove surface regions 112b may include a second-first guide groove surface region 112b-1 and a second-second guide groove surface region 112b-2 provided to be spaced apart from each other in the circumferential direction with the first guide groove surface region 112a interposed therebetween. More specifically, as illustrated in FIGS. 2 and 4, the second-first guide groove surface region 112b-1 and the second-second guide groove surface region 112b-2 may be provided to extend in directions intersecting each other. That is, the second-first guide groove surface region 112b-1 and the second-second guide groove surface region 112b-2 may not be parallel to each other.

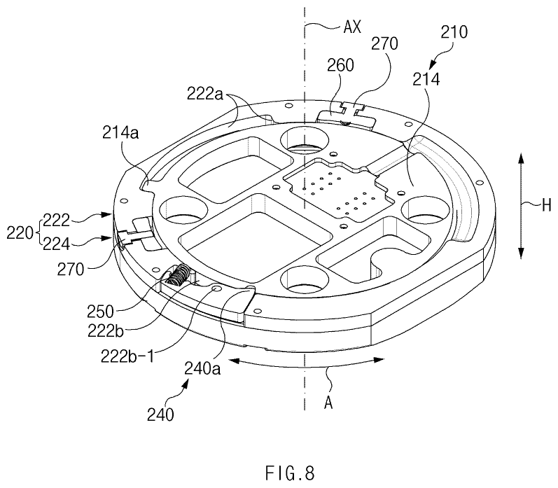

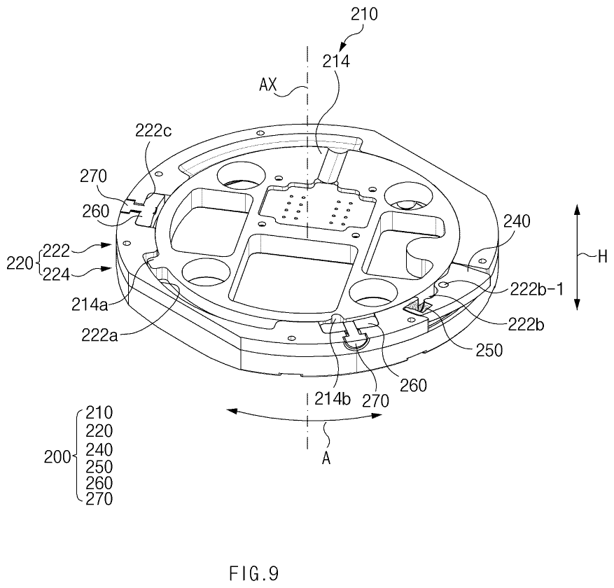

FIG. 8 is a view illustrating a structure of a horizontal cross-section of the coupling part and illustrating a state in which the sleeve member is fixedly coupled to the base member by the latch member, and FIG. 9 is a view illustrating the structure of the horizontal cross-section of the coupling part and illustrating a state in which the sleeve member and the base member are uncoupled.

The assembly structure 10 may further include a configuration that provides a force to allow the latch member 240 to press the recessed region 214b so that the state in which the latch member 240 is inserted into the recessed region 214b may be maintained even after the latch member 240 is inserted into the recessed region 214b. More specifically, the coupling part 200 may further include an elastic member 250. The elastic member 250 is provided to face the insertion region 240a of the latch member 240 with the latch rotation shaft 222b-1 interposed therebetween, and the elastic member 250 is provided between the latch member 240 and the outer peripheral surface of the base protruding portion 214. The elastic member 250 may be configured to press the latch member 240 in a direction (i.e., the radial direction) away from the rotation center axis AX. Therefore, the insertion region 240a of the latch member 240 may press the recessed region 214b by means of the force applied by the elastic member 250 to press the latch member 240, thereby preventing the insertion region 240a of the latch member 240 from separating from the recessed region 214b.

According to an exemplary example of the present disclosure, a user may manipulate the latch member 240 in a direction away from the insertion region 240a. That is, when the user presses the region of the latch member 240 that faces the insertion region 240a with the latch rotation shaft 222b-1 interposed therebetween, such that the insertion region 240a may move in the direction away from the recessed region 214b while overcoming a restoring force of the elastic member 250. In this case, as illustrated in FIGS. 8 and 9, an outer surface of the region of the latch member 240, which faces the elastic member 250, may be exposed to the outside so that the user may easily manipulate the latch member 240. This configuration may be understood as a configuration in which the accommodation space for the latch member 240, which is defined by the latch accommodation groove 222b, is opened in the direction (i.e., radial direction) away from the rotation center axis AX. In this case, because the user may press the region of the latch member 240, which is exposed to the outside, toward the rotation center axis AX as if the user pushes a button, it is possible to easily adjust a degree to which the insertion region 240a and the recessed region 214b are spaced apart from each other, and it is possible to easily uncouple the assembling part 100 and the coupling part 200.

With reference back to FIG. 7, the lower sleeve 224 may have flange insertion regions 224a defined in a part of an inner peripheral surface of the lower sleeve 224 and each having a shape recessed outward, i.e., in the direction away from the rotation center axis AX. In addition, with reference to FIGS. 2 to 4, the flange 120 may have flange projection regions 124 protruding outward from the outer peripheral surface of the flange 120, i.e., protruding in the direction away from the rotation center axis AX. In this case, according to the present disclosure, a width of the flange insertion region 224a in the circumferential direction A of the assembly structure 10 may be larger than a width of the flange projection region 124 in the circumferential direction A or corresponds to the width of the flange projection region 124. More particularly, the width of the flange insertion region 224a in the circumferential direction A may be finely larger than or substantially equal to the width of the flange projection region 124 in the circumferential direction A. This is to allow the flange projection region 124 to pass through the flange insertion region 224a, i.e., allow the flange 120 to pass through the lower sleeve 224 only in a case in which the flange projection region 124 is placed at a predetermined rotated position relative to the lower sleeve 224.

According to the present disclosure, during a process in which the assembling part 100 moves upward from the lower region of the coupling part 200 during the process of coupling the assembling part 100 and the coupling part 200, the flange projection region 124 may pass through a space, which is defined by the flange insertion region 224a, and then the flange 120 may come into close contact with a lower surface of the base flange 212. More particularly, in case that the pin members 230 are provided as a plurality of pin members 230 and the plurality of pin members 230 are respectively inserted into the pin insertion grooves 122 defined in the upper surface of the flange 120 such that the flange 120 and the base flange 212 are in close contact with each other, the flange projection regions 124 may face, in the upward/downward direction, the spaces defined by the flange insertion regions 224a, and the flange projection regions 124 may be defined above the spaces defined by the flange insertion regions 224a. This configuration may be understood as a configuration in which when the pin member 230 is inserted into the pin insertion groove 122, the flange projection region 124 may pass through the flange insertion region 224a and be positioned in an upper region of the flange insertion region 224a.

The assembly structure 10 may include a configuration that prevents the assembling part 100 and the coupling part 200 from separating from each other in the upward/downward direction H when the assembling part 100 and the coupling part 200 are completely coupled. More specifically, according to the present disclosure, the sleeve member 220 and the flange 120 may be configured to interfere with each other in the upward/downward direction H when a rotation angle of the sleeve member 220 with respect to the base member 210 is within a predetermined range.

More specifically, the interference between the flange 120 and the sleeve member 220 in the upward/downward direction H may occur when the sleeve member 220 is rotated after the flange projection region 124 defined on the flange 120 passes through the flange insertion region 224a and the flange projection region 124 reaches an upper side of the flange insertion region 224a. That is, when the sleeve member 220 is rotated by a predetermined rotation angle after the flange projection regions 124 pass through the flange insertion regions 224a and the flange projection regions 124 reach the upper sides of the flange insertion regions 224a, at least a part of a lower region of each of the flange projection regions 124 does not face each of the flange insertion regions 224a any further, and the flange projection regions 124 face sleeve projection regions 224b (see FIGS. 3 and 7) each having a shape extending in the circumferential direction A from an end of the flange insertion region 224a based on the circumferential direction A on the inner peripheral surface of the lower sleeve 224 and protruding inward toward the rotation center axis AX. That is, the sleeve projection region 224b may be defined in a region of the inner peripheral surface of the lower sleeve 224 in which the flange insertion region 224a is not defined. The inner peripheral surface of the lower sleeve 224 may have a concave-convex structure in which the flange insertion regions 224a and the sleeve projection regions 224b are alternately defined in the circumferential direction A.

That is, according to the present disclosure, the interference between the flange projection region 124 and the sleeve projection region 224b may prevent the assembling part 100, which includes the flange 120, and the coupling part 200, which includes the lower sleeve 224, from separating from each other in the upward/downward direction H. A spring member (not illustrated) may be additionally provided between the lower surface of the base flange 212 and the upper surface of the flange 120. For example, one side of the spring member may be fixedly coupled to the lower surface of the base flange 212 or the upper surface of the flange 120. In this case, the spring member may press the lower surface of the base flange 212 and the upper surface of the flange 120 upward and downward. Therefore, in case that the assembling part 100 and the coupling part 200 are coupled, a state in which the flange projection region 124 and the sleeve projection region 224b are in close contact with each other while pressing each other may be maintained, such that the assembling part 100 and the coupling part 200 may be more stably coupled.

As illustrated in FIG. 8, according to the example of the present disclosure, the insertion region 240a of the latch member 240 may face the recessed region 214b of the base protruding portion 214 in the state in which the sleeve member 220 is rotated relative to the base member 210 so that the interference region 214a of the base member 210 is provided adjacent to a boundary of one side of the rotation interference groove 222a of the upper sleeve 222 based on the circumferential direction A. That is, the insertion region 240a may be inserted into the recessed region 214b in the state in FIG. 8. More particularly, in the state in which the insertion region 240a is inserted into the recessed region 214b, the boundary of one side of the rotation interference groove 222a based on the circumferential direction A may be in contact with the interference region 214a.

In contrast, as illustrated in FIG. 9, according to the example of the present disclosure, the insertion region 240a of the latch member 240 may be spaced apart from the recessed region 214b of the base protruding portion 214 in the circumferential direction A in the state in which the sleeve member 220 is rotated relative to the base member 210 so that the interference region 214a of the base member 210 is provided adjacent to a boundary of the other side of the rotation interference groove 222a of the upper sleeve 222 based on the circumferential direction A. In this case, when the assembly structure 10 is viewed from above the assembly structure 10 in the state in FIG. 9, the entire flange projection region 124 of the flange 120 may be accommodated in the flange insertion region 224a of the lower sleeve 224, as illustrated in FIG. 3. That is, the state illustrated in FIG. 9 may correspond to a state in which the flange projection region 124 may pass through the flange insertion region 224a during the process in which the assembling part 100 including the flange 120 is coupled to the coupling part 200 including the sleeve member 220. More particularly, the boundary of the other side of the rotation interference groove 222a may be in contact with the interference region 214a in the state in which the entire flange projection region 124 of the flange 120 is provided to be accommodated in the flange insertion region 224a of the lower sleeve 224 when the assembly structure 10 is viewed from above.

According to the present disclosure, in order to more securely couple the base member 210 and the sleeve member 220, the assembly structure 10 may further include another configuration in addition to the latch member 240.

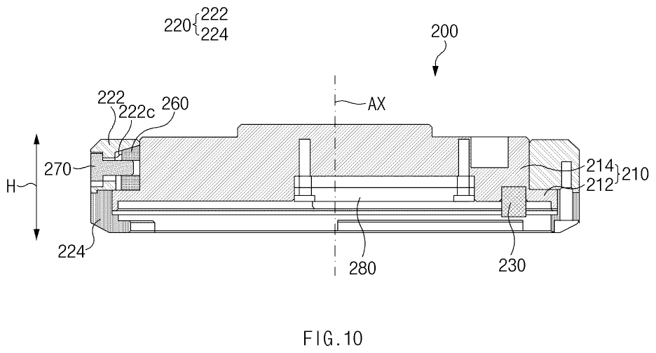

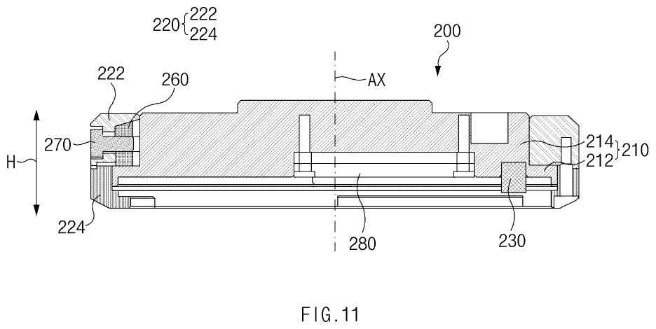

FIG. 10 is a vertical cross-sectional view illustrating the coupling part and illustrating a state made before the sleeve member is moved upward by bolt-nut coupling between a bolt member and a sliding member, and FIG. 11 is a vertical cross-sectional view illustrating the coupling part and illustrating a state made after the sleeve member is moved upward by bolt-nut coupling between the bolt member and the sliding member.

With reference to FIGS. 10 and 11, the coupling part 200 may further include a sliding member 260 accommodated in the upper sleeve 222, and a bolt member 270 configured to be inserted into an outer peripheral surface of the upper sleeve 222 and the sliding member 260. More specifically, a sliding member coupling groove 222c (see FIG. 6) may be defined in a peripheral region of the upper sleeve 222. The sliding member coupling groove 222c has a recessed shape and defines a space in which the sliding member 260 is accommodated. The shape and size of the sliding member coupling groove 222c may correspond to the shape and size of the sliding member 260.

A coupling force between the base member 210 and the sleeve member 220 may be increased by adjusting a degree to which the sliding member 260 and the bolt member 270 are coupled to each other. As a result, it is possible to implement the increased coupling between the coupling part 200 and the flange 120.

In particular, according to the present disclosure, the upper surface of the flange 120 may be pressed against and provided to be in close contact with the lower surface of the base flange 212 of the coupling part 200 by means of the sliding member 260 and the bolt member 270, such that clamping coupling between the coupling part 200 and the flange 120 may be implemented.

In order to achieve the above-mentioned object, according to the present disclosure, the sleeve member 220 may be moved in the upward/downward direction H relative to the base member 210 by adjusting a degree of bolt-nut coupling between the sliding member 260 and the bolt member 270. More specifically, with reference to FIGS. 4, 10, and 11, the upper surface of the sliding member 260 may include a shape of an inclined surface having a height, in the upward/downward direction H, that decreases in the direction away from the rotation center axis AX, i.e., in the radial direction. The region of the sliding member coupling groove 222c, which faces the upper surface of the sliding member 260, may include a shape corresponding to the inclined surface defined on the upper surface of the sliding member 260. For example, the entire upper surface of the sliding member 260 may have a shape of an inclined surface.

Because the upper surface of the sliding member 260 has the inclined surface and the sliding member coupling groove 222c has the shape corresponding to the inclined surface, the sleeve member 220 may be moved in the upward/downward direction H relative to the base member 210 by interference between the sliding member 260 and the sliding member coupling groove 222c.

That is, with reference to FIGS. 10 and 11, when the bolt member 270 rotates and the bolt-nut coupling between the bolt member 270 and the sliding member 260 is adjusted, a relative horizontal position between the bolt member 270 and the sliding member 260 varies. In this case, because the bolt member 270 penetrates the upper sleeve 222 and is coupled to the sliding member 260, a horizontal movement of the bolt member 270 is restricted by a lateral surface of the upper sleeve 222, but the sliding member 260 moves in the horizontal direction. In order to allow the horizontal movement of the sliding member 260, a horizontal width of the internal space defined by the sliding member coupling groove 222c may be larger than a horizontal width of the sliding member 260.

Therefore, when the sliding member 260 moves in the horizontal direction, the sleeve member 220, which includes the upper sleeve 222 that accommodates the sliding member 260, is moved in the upward/downward direction relative to the base member 210 by interference between the inclined surface, which is defined on the upper surface of the sliding member 260, and the sliding member coupling groove 222c that faces the inclined surface.

For example, when the bolt member 270 rotates and the sliding member 260 moves toward the rotation center axis AX, the sleeve member 220 is moved downward relative to the base member 210 (before clamping coupling), as illustrated in FIG. 10. In contrast, when the bolt member 270 rotates and the sliding member 260 moves in the direction away from the rotation center axis AX, the sleeve member 220 is moved upward relative to the base member 210 (clamping coupling), as illustrated in FIG. 11.

In order to provide a route along which the sleeve member 220 may be moved in the upward/downward direction H by the rotation of the bolt member 270, a size in the upward/downward direction H of a hole defined in a region of the upper sleeve 222 into which the bolt member 270 is inserted may be larger than a size in the upward/downward direction H of a region of the bolt member 270 inserted into the upper sleeve 222. In addition, a size in the upward/downward direction H of a hole defined in a region of the sliding member 260 into which the bolt member 270 is inserted may correspond to a size in the upward/downward direction H of a region of the bolt member 270 inserted into the sliding member 260. As illustrated in FIGS. 10 and 11, according to the example of the present disclosure, a lower surface of the sliding member 260 may be provided to be in close contact with an upper surface of the base flange 212, and the lower surface of the sliding member 260 may be perpendicular to the rotation center axis AX. That is, the lower surface of the sliding member 260 may include no inclined surface.

In contrast, unlike the configuration illustrated in FIGS. 10 and 11, the inclined surface defined on the sliding member 260 may be defined on the lower surface of the sliding member 260. That is, according to another example of the present disclosure, the lower surface of the sliding member 260 may include a shape of an inclined surface having a height, in the upward/downward direction H, that increases in the direction away from the rotation center axis AX. The lower surface of the sliding member 260 may be provided to be in close contact with the upper surface of the base flange 212. In this case, a region of the upper surface of the base flange 212, which faces the lower surface of the sliding member 260, may include a shape corresponding to the inclined surface defined on the lower surface of the sliding member 260. In addition, the upper surface of the sliding member 260 may be provided to be in close contact with the sliding member coupling groove 222c, and the upper surface of the sliding member 260 may be perpendicular to the rotation center axis AX. In a similar principle to the case in which the inclined surface is defined on the upper surface of the sliding member 260, the relative movement between the sleeve member 220 and the base member 210 may be performed in the upward/downward direction H even in the case in which the inclined surface is defined on the lower surface of the sliding member 260.

The assembly structure 10 may further include a configuration that electrically connects the assembling part 100 and the coupling part 200.

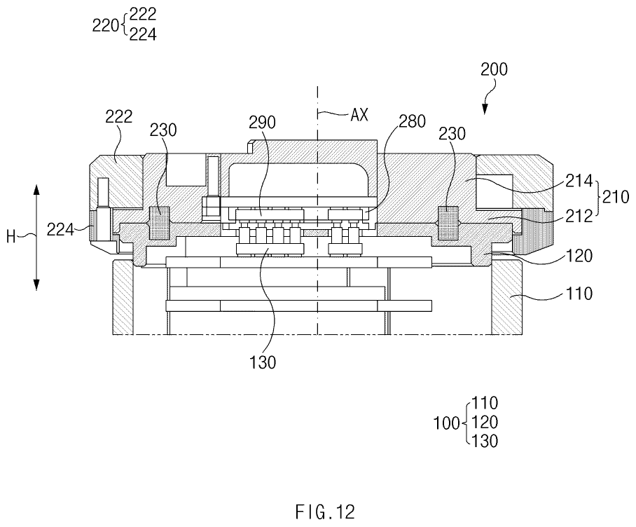

FIG. 12 is a vertical cross-sectional view illustrating the assembly structure and illustrating a state made after the assembling part and the coupling part are completely coupled.

With reference to FIGS. 4 and 12, the coupling part 200 may include a connector cover 280 accommodated in a lower surface of the base flange 212, and a coupling part connector 290 provided between the connector cover 280 and a region of the lower surface of the base flange 212 that accommodates the connector cover 280. In addition, the assembling part 100 may include an assembling part connector 130 accommodated in the internal space of the assembling part 100. In this case, the assembling part connector 130 may penetrate the connector cover 280 and be inserted and coupled into the coupling part connector 290. In particular, in the case of the structure of the assembly structure 10 according to the present disclosure, the connector structures with various shapes including a plug-socket type connector structure may be applied to the assembly structure 10.

Hereinafter, the station will be described with reference to the drawings.

### Station

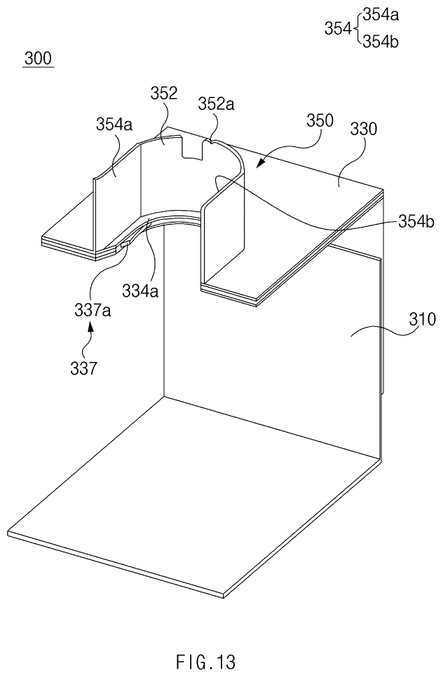

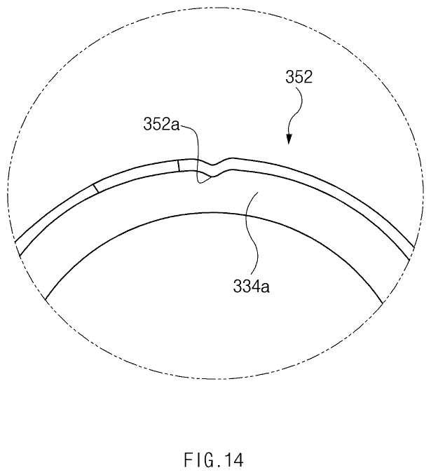

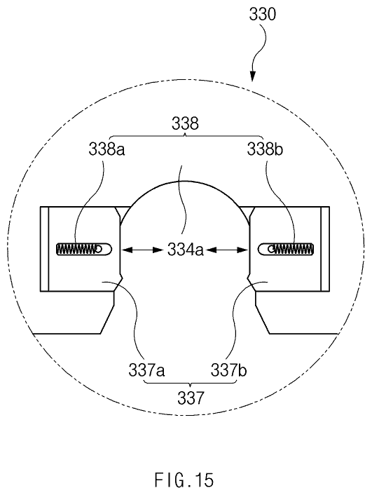

FIG. 13 is a perspective view of the station according to the present disclosure, and FIG. 14 is an enlarged cross-sectional view illustrating a first holder part surface region formed on a station holder part of the station according to the present disclosure. In addition, FIG. 15 is an enlarged cross-sectional view illustrating an assembling part seating region of a station base part of the station and peripheral components thereof according to the present disclosure.

A station 300 may be configured to automatically couple and uncouple the assembling part 100 and the coupling part 200 of the assembly structure 10 according to the present disclosure.

More specifically, as illustrated in FIGS. 13 to 15, the station 300 may include a station body part 310 configured to define a body of the station 300, a station base part 330 fixed to one side of the station body part 310, and a station holder part 350 having a shape protruding upward from an upper surface of the station base part 330. For example, the station base part 330 may have a plate shape having an approximately constant thickness in the upward/downward direction.

An assembling part seating region 334a may be formed on the station base part 330 and have a shape recessed inward in a horizontal direction. The body 110 may be seated on the assembling part seating region 334a. More specifically, during the process in which the station 300 couples and uncouples the assembling part 100 and the coupling part 200, the guide groove region 112 of the body 110 may be seated on the assembling part seating region 334a, and a lower surface of a portion of the body 110, which is connected to an upper end of the guide groove region 112, may be supported by an upper surface of the station base part 330.

The station holder part 350 may be a component on which the coupling part 200 is seated during the process in which the assembling part 100 and the coupling part 200 are coupled and uncoupled. More specifically, the station holder part 350 may have a shape protruding upward from an upper surface of a portion of the station base part 330 where the assembling part seating region 334a is formed.

In addition, a horizontal cross-sectional shape of the station holder part 350 may correspond to a horizontal cross-sectional shape of the assembling part seating region 334a. More particularly, the station holder part 350 may have a shape spaced apart upward from an upper surface of a region spaced apart, at a predetermined interval, from an inner surface of a portion of the station base part 330 that defines the assembling part seating region 334a. The horizontal cross-section of the station holder part 350 and the horizontal cross-section of the assembling part seating region 334a may each have an approximately ‘U’ shape.

An inner surface of the station holder part 350 may be divided into a plurality of regions depending on the shape thereof. More specifically, the inner surface of the station holder part 350 may include the first holder part surface region 352 having a shape curved in a direction intersecting the upward/downward direction, and the second holder part surface regions 354 each connected to one side end of the first holder part surface region 352 and having a curvature different from a curvature of the first holder part surface region 352.

With reference to FIGS. 2 to 4 and 13 to 15, during the process in which the assembling part 100 and the coupling part 200 are coupled and uncoupled, the first holder part surface region 352 may come into contact with the first sleeve surface region 220-1 provided on the sleeve member 220 of the coupling part 200, and the second holder part surface region 354 may come into contact with the second sleeve surface region 220-2 provided on the sleeve member 220. Therefore, a shape of the first holder part surface region 352 may correspond to a shape of the first sleeve surface region 220-1, and a shape of the second holder part surface region 354 may correspond to a shape of the second sleeve surface region 220-2.

More specifically, an inner portion of a cross-section, which is made by cutting the first holder part surface region 352 in the direction intersecting the upward/downward direction, may have an approximately circumferential shape, and an inner portion of a cross-section, which is made by cutting the second holder part surface region 354 in the direction intersecting the upward/downward direction, may have a line segment shape.

In addition, the second holder part surface regions 354 may include a second-first holder part surface region 354a and a second-second holder part surface region 354b provided to be spaced apart from each other in the circumferential direction of the first holder part surface region 352 with the first holder part surface region 352 interposed therebetween. For example, as illustrated in FIG. 13, the second-first holder part surface region 354a and the second-second holder part surface region 354b may be provided in parallel with each other.

As described above, an inner portion of a horizontal cross-section of the first holder part surface region 352 may have an approximately circumferential shape. However, a partial region of the inner surface of the first holder part surface region 352 may have a protruding shape. More specifically, as illustrated in FIG. 14, the first holder part surface region 352 may include a protruding pressing portion 352a (e.g., protrusion) provided on the inner surface of the first holder part surface region 352 and having a shape protruding inward. For example, a distance between the protruding pressing portion 352a and the second-first holder part surface region 354a may be substantially equal to a distance between the protruding pressing portion 352a and the second-second holder part surface region 354b.

When the coupling part 200 enters the station holder part 350, the protruding pressing portion 352a may press the latch member 240 provided on the coupling part 200 so that the insertion region 240a of the latch member 240 moves away from the recessed region 214b of the base protruding portion 214, such that the sleeve member 220 may be in a state of being rotatable relative to the base member 210. In order to exhibit the above-mentioned function, the protruding pressing portion 352a may be configured to come into contact with a portion of the latch member 240, which faces the insertion region 240a with the latch rotation shaft 222b-1 interposed therebetween, when the coupling part 200 enters the station holder part 350.

The station base part 330 may further include a configuration provided to be movable in the horizontal direction by the guide groove region 112 when the guide groove region 112 of the body 110 is seated on the assembling part seating region 334a.

More specifically, with reference to FIGS. 13 and 15, the station base part 330 may include movement block members 337 (movement blocks) provided in an inner surface of the assembling part seating region 334a and configured to be movable in a direction toward a space defined by the assembling part seating region 334a and a direction away from the space, and pressing springs 338 each provided at one side of each of the movement block members 337 and configured to press the movement block members 337 toward the space defined by the assembling part seating region 334a. Therefore, when the guide groove region 112 is seated on the assembling part seating region 334a, the movement block members 337 may be moved in the horizontal direction by being pressed by the guide groove region 112. When a pressing force of the guide groove region 112 is eliminated, the movement block members 337 may be returned to original states by pressing forces of the pressing springs 338. For example, as illustrated in FIGS. 13 and 15, the movement block members 337 may include a first movement block member 337a and a second movement block member 337b provided to face each other with the space, which is defined by the assembling part seating region 334a, interposed therebetween. The pressing springs 338 may include a first pressing spring 338a and a second pressing spring 338b respectively provided at one side of the first movement block member 337a and one side of the second movement block member 337b and configured to press the first movement block member 337a and the second movement block member 337b. More particularly, the first guide groove surface region 112a and the second guide groove surface region 112b may respectively come into contact with the first movement block member 337a and the second movement block member 337b. However, in this case, the contact between the first guide groove surface region 112a and the first movement block member 337a and the contact between the second guide groove surface region 112b and the second movement block member 337b may be selectively performed without being performed simultaneously. Therefore, as described above, the second-first guide groove surface region and the second-second guide groove surface region extend in the directions intersecting each other, whereas a surface of the first movement block member 337a, which is directed toward the space defined by the assembling part seating region 334a (i.e., a surface to be brought into contact with the second-first guide groove surface region), and a surface of the second movement block member 337b, which is directed toward the space defined by the assembling part seating region 334a (i.e., a surface to be brought into contact with the second-second guide groove surface region), may be formed in parallel with each other.

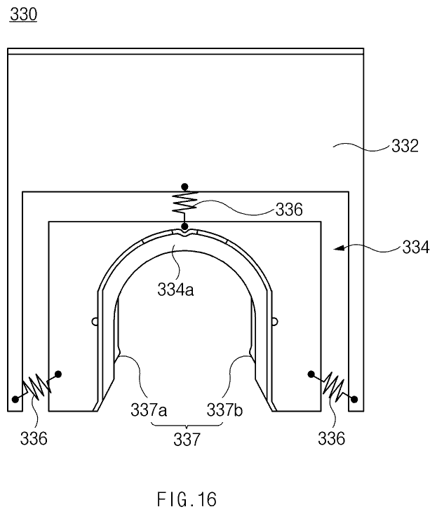

FIG. 16 is a top plan view illustrating another example of the station base part of the station according to the present disclosure.

A structure of the station base part 330 illustrated in FIG. 16 is basically similar to the structure of the station base part described above with reference to FIGS. 13 to 15 and differs from the structure of the station base part described above with reference to FIGS. 13 to 15 in that the body, which constitutes the station base part, is provided as a plurality of bodies configured to be movable relative to one another. The description of the station base part 330 illustrated in FIG. 16 may be replaced with the description of the station base part 330 described above with reference to FIGS. 13 to 15, except for the following description of the structure of the station base part 330 to be described below with reference to FIG. 16.

With reference to FIG. 16, the station base part 330 may include a main base body 332, an auxiliary base body 334 provided to be spaced apart from the main base body 332, and elastic connection bodies 336 configured to connect the main base body 332 and the auxiliary base body 334. In this case, the assembling part seating region 334a may be formed on the auxiliary base body 334 and coupled to the movement block members 337.

According to the structure described above with reference to FIG. 16, an impact to be applied to the station base part 330 may be minimized during the process in which the assembling part 100 and the coupling part 200 are coupled and uncoupled in the station. That is, according to the structure described above with reference to FIG. 16, in case that an impact is applied to the auxiliary base body 334 of the station base part 330 during the process in which the assembling part 100 and the coupling part 200 are coupled and uncoupled, the auxiliary base body 334 moves while lengths of the elastic connection bodies 336 are changed, such that a magnitude of an impact force to be applied to the auxiliary base body 334 may be reduced in comparison with the case in which the auxiliary base body 334 is fixed without moving. The elastic connection body 336 may be used without limitation as long as the elastic connection body 336 may be reversibly deformed in shape by an external force. For example, the elastic connection body 336 may be a spring or a wire made of a material with elasticity.

Hereinafter, a process of coupling the robot arm and the gripper by coupling the coupling part and the assembling part of the assembly structure in the station will be described with reference to the above-mentioned description and the drawings.

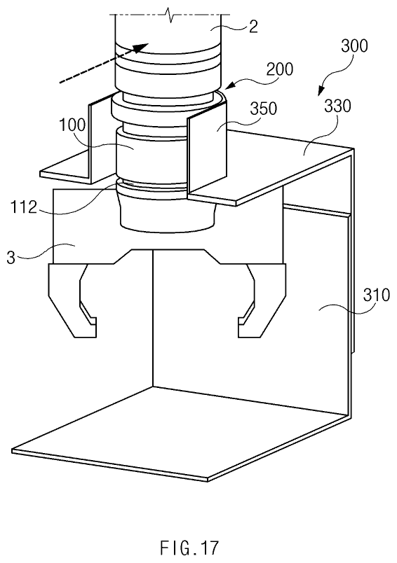

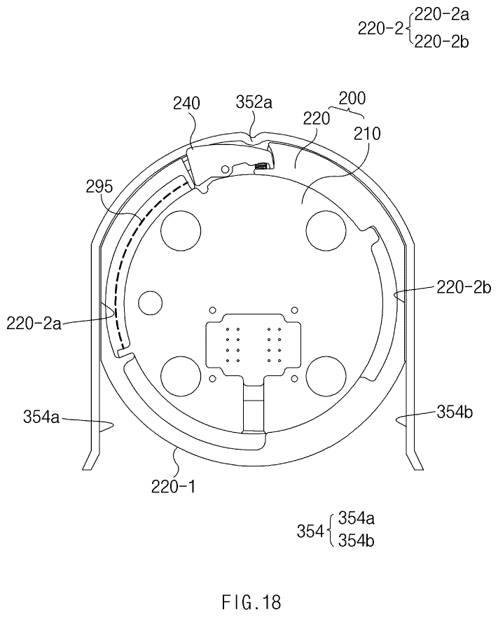

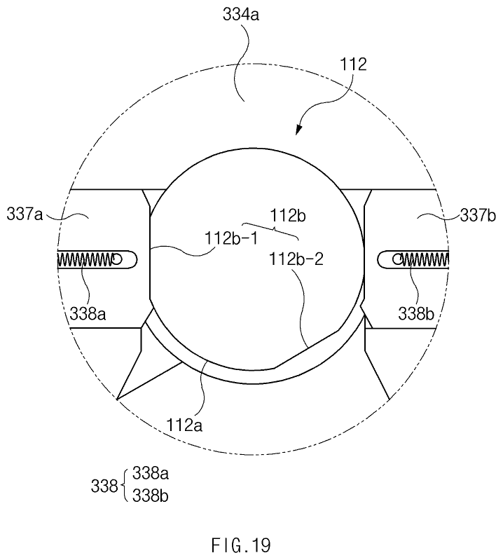

FIG. 17 is a view illustrating a state in which the robot arm including the coupling part enters the station in a state in which the gripper including the assembling part is seated on the station according to the present disclosure, and FIG. 18 is a cross-sectional view illustrating a state of an interior of the coupling part when the coupling part enters the station in FIG. 17. FIG. 19 is a cross-sectional view illustrating a state of the assembling part seated on the station in FIG. 17.

With reference to FIGS. 17 to 19, the assembling part 100, which is coupled to the gripper 3, and the coupling part 200, which is coupled to the robot arm 2, are respectively seated on the station base part 330 and the station holder part 350 of the station 300. More specifically, the assembling part 100 is seated on the station base part 330 as the guide groove region 112 is positioned in the space defined by the assembling part seating region 334a. The coupling part 200 is seated on the station holder part 350 as the second sleeve surface region 220-2, which is formed on the sleeve member 220, comes into close contact with the second holder part surface region 354.

In this case, as illustrated in FIG. 18, when the coupling part 200 is seated on the station holder part 350 until the first sleeve surface region 220-1 comes into close contact with the first holder part surface region 352, the protruding pressing portion 352a, which is formed on the first holder part surface region 352, presses the latch member 240 of the coupling part 200, such that the latch member 240 moves away from the recessed region 214b of the base protruding portion 214. Therefore, the sleeve member 220 and the base member 210 of the coupling part 200 are in a state of being movable relative to each other.

As illustrated in FIG. 19, in the state in which the assembling part 100 is seated on the station base part 330, the second-first guide groove surface region 112b-1 of the guide groove region 112 is in close contact with the first movement block member 337a, and the second-second guide groove surface region 112b-2 is spaced apart from the second movement block member 337b in the circumferential direction.

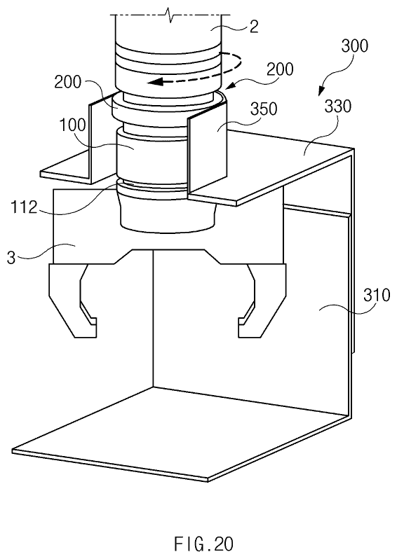

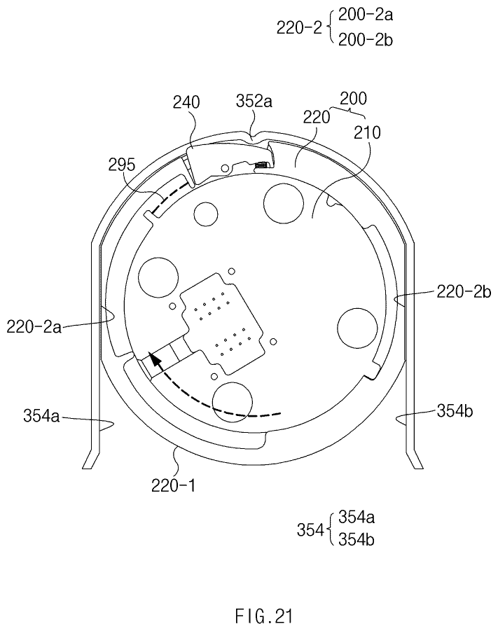

FIG. 20 is a view illustrating a state in which the robot arm is rotated so that the coupling part is in a state of being capable of being coupled to the gripper after the coupling part enters the station according to the present disclosure, and FIG. 21 is a cross-sectional view illustrating a state of the interior of the coupling part when the robot arm is rotated in FIG. 20.

As described above, when the robot arm 2 rotates in the state in which the sleeve member 220 and the base member 210 are capable of rotating relative to each other, the base member 210 fixed with respect to the robot arm 2 rotates. For example, as illustrated in FIGS. 20 and 21, when the base member 210 rotates clockwise, the interference region 214a of the base protruding portion 214 moves in the direction toward the latch member 240 while compressing the elastic pressing member 295. The rotation of the robot arm is performed until the pin member 230 (see FIG. 4), which is coupled to the lower surface of the base flange 212 (see FIG. 4), and the pin insertion groove 122 (see FIG. 4), which is formed in the upper surface of the flange 120 (see FIG. 4), are positioned to face each other in the upward/downward direction.

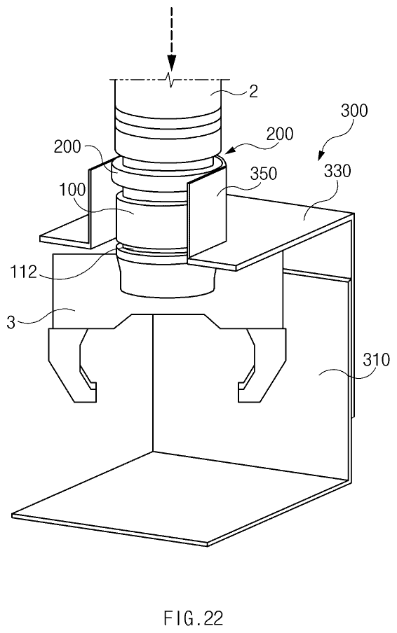

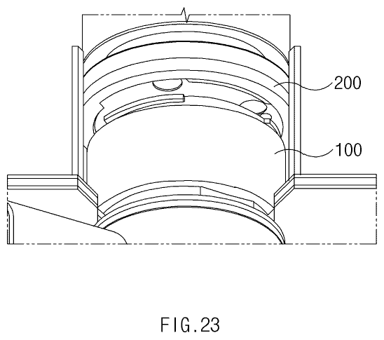

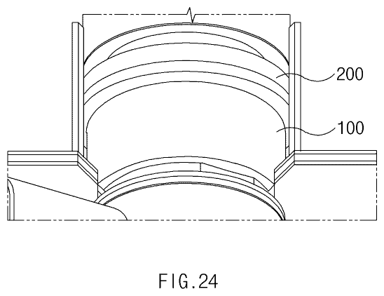

FIG. 22 is a view illustrating a state in which the robot arm is moved downward and the coupling part is coupled to the assembling part in the station according to the present disclosure, and FIG. 23 is a view illustrating a state in which the coupling part and the assembling part are spaced apart from each other before the robot arm is moved downward in FIG. 22. FIG. 24 is a view illustrating a state in which the robot arm is moved downward in FIG. 22 and the coupling part and the assembling part are coupled to each other.

When the pin member and the pin insertion groove are positioned to face each other in the upward/downward direction as described above, the robot arm 2 moves downward, and the pin member is inserted into the pin insertion groove, as illustrated in FIG. 22. FIG. 23 illustrates the state in which the assembling part 100 and the coupling part 200 are spaced apart from each other in the upward/downward direction before the robot arm 2 moves downward, and FIG. 24 illustrates the state in which the robot arm 2 is moved downward, and the assembling part 100 and the coupling part 200 are coupled to each other. When the pin member is inserted into the pin insertion groove, the assembling part 100 and the coupling part 200 are fixed to each other so that the assembling part 100 and the coupling part 200 cannot rotate relative to each other.

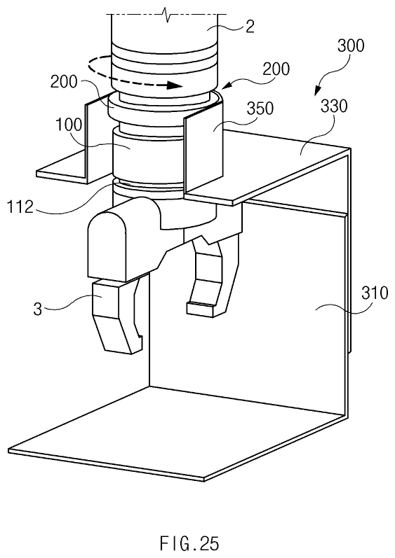

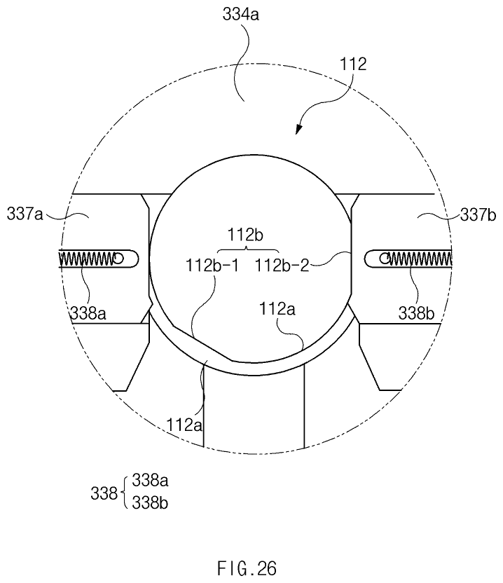

FIG. 25 is a view illustrating a state in which the robot arm rotates in a state in which the coupling part and the assembling part are coupled to each other in the station according to the present disclosure, and FIG. 26 is a cross-sectional view illustrating a state of the assembling part seated on the station in FIG. 25.

As illustrated in FIG. 25, when the robot arm 2 rotates in the state in which the assembling part 100 and the coupling part 200 are fixed to each other so that the assembling part 100 and the coupling part 200 cannot rotate relative to each other, the assembling part 100 and the coupling part 200 rotate together, except for the sleeve member 220, in the state in which the sleeve member 220 is fixed by the station holder part 350. The rotation of the assembling part 100 and the rotation of the coupling part 200 may be performed to prevent the assembling part 100 and the coupling part 200 from moving away from each other in the upward/downward direction. That is, the rotation of the assembling part 100 is performed until the sleeve projection region 224b (see FIG. 7 and the like) of the lower sleeve 224 (see FIG. 7 and the like) and the flange projection region 124 (see FIG. 4 and the like) of the flange 120 (see FIG. 4 and the like) face each other in the upward/downward direction. When the assembling part 100 is rotated by the rotation of the robot arm 2, the guide groove region 112 provided on the body 110 of the assembling part 100 also rotates. In this case, as illustrated in FIG. 26, the rotation of the robot arm 2 may be performed until the second-first guide groove surface region 112b-1 of the guide groove region 112 moves away from the first movement block member 337a in the circumferential direction and the second-second guide groove surface region 112b-2 comes into close contact with the second movement block member 337b.

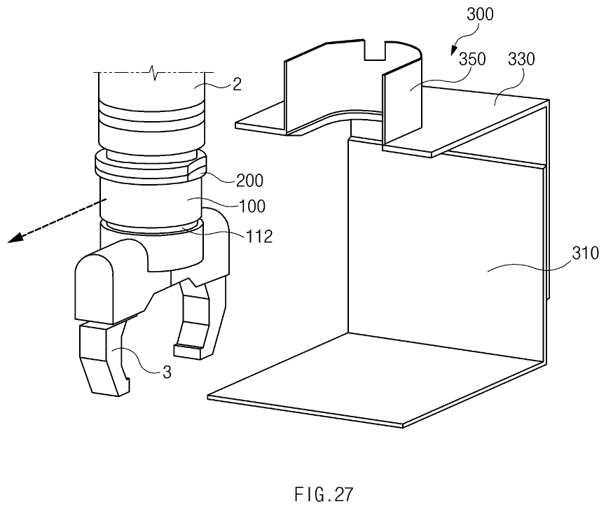

FIG. 27 is a view illustrating a state in which the robot arm and the gripper are separated from the station.

The assembly of the robot arm 2 and the gripper 3 is separated from the station 300 after the assembling part 100 and the coupling part 200 are coupled so that the assembling part 100 and the coupling part 200 are prevented from being separated from each other in the upward/downward direction. When the assembly of the robot arm 2 and the gripper 3 is separated from the station 300, the latch member 240 (see FIG. 21 and the like) is released from the protruding pressing portion 352a, and the insertion region 240a (see FIG. 21 and the like) of the latch member is inserted back into the recessed region 214b of the base protruding portion 214. Therefore, the assembling part 100 and the coupling part 200 are completely coupled.

The present disclosure has been made in an effort to provide a structure for connecting a robot arm and a gripper, the structure being capable of adopting various types of connector structures that can be easily mounted and detached in comparison with the related art, and provide a station capable of easily coupling and uncoupling the connection structure.

In order to achieve the above-mentioned object, one aspect of the present disclosure provides an assembly structure including: an assembling part; and a coupling part provided above the assembling part and configured to be attachable to or detachable from the assembling part, in which the assembling part includes: a body configured to define a body of the assembling part and opened at an upper side thereof; and a flange fixedly coupled to an upper portion of the body, in which the coupling part includes: a base member; and a sleeve member configured to surround a periphery of the base member and opened at a lower side thereof, in which the flange is configured to penetrate the sleeve member and face the base member, and a rotational motion of the flange about a rotation center axis AX of the assembly structure relative to the base member is restricted, in which the sleeve member is configured to rotatable relative to the base member, and in which the sleeve member and the flange are configured to interfere with each other in an upward/downward direction H when a rotation angle of the sleeve member with respect to the base member is within a predetermined range.

An outer surface of the sleeve member based on a radial direction perpendicular to the rotation center axis AX may include: a first sleeve surface region having a curved shape that surrounds the rotation center axis AX; and second sleeve surface regions each connected to one side end of the first sleeve surface region and having a curvature different from a curvature of the first sleeve surface region.

A radially outer portion of a cross-sectional shape, which is made by cutting the second sleeve surface region in a direction perpendicular to the rotation center axis AX, may have a line segment shape.

The second sleeve surface regions may include a second-first sleeve surface region and a second-second sleeve surface region provided to be spaced apart from each other in a circumferential direction with the first sleeve surface region interposed therebetween.

The second-first sleeve surface region and the second-second sleeve surface region may be provided in parallel with each other.

The base member may include: a base flange; and a base protruding portion protruding upward from the base flange, an interference region may be defined on an outer peripheral surface of the base protruding portion and have a shape protruding outward, the sleeve member may include an upper sleeve configured to define an upper region of the sleeve member and surround the outer peripheral surface of the base protruding portion, the upper sleeve may have a rotation interference groove defined in an inner peripheral surface of the upper sleeve and configured to accommodate the interference region, the interference region may be configured to interfere with the upper sleeve at a boundary of the rotation interference groove based on a circumferential direction A, and the coupling part may further include an elastic pressing member accommodated in the rotation interference groove and extending in the circumferential direction.

A recessed region may be defined in the outer peripheral surface of the base protruding portion and spaced apart from the interference region in the circumferential direction A, the recessed region may have a shape recessed inward, the coupling part may further include a latch member rotatably coupled to the upper sleeve and having at least a partial region configured to be inserted into the recessed region in a state in which the sleeve member is coupled to the base member so that the interference region is placed in the rotation interference groove, one side end of the elastic pressing member may be provided to face one side boundary of the rotation interference groove based on the circumferential direction A, and the other side end of the elastic pressing member may be provided to face the interference region.

The body may include a guide groove region formed in an outer surface of the body based on the radial direction perpendicular to the rotation center axis AX, the guide groove may have a shape extending in a circumferential direction A and recessed radially inward, and an outer surface of the guide groove region based on the radial direction may include: a first guide groove surface region having a curved shape that surrounds the rotation center axis AX; and second guide groove surface regions each connected to one side end of the first guide groove surface region and having a curvature different from a curvature of the first guide groove surface region.

A radially outer portion of a cross-sectional shape, which is made by cutting the second guide groove surface region in a direction perpendicular to the rotation center axis AX, may have a line segment shape.

The second guide groove surface regions may include a second-first guide groove surface region and a second-second guide groove surface region provided to be spaced apart from each other in the circumferential direction with the first guide groove surface region interposed therebetween.

The second-first guide groove surface region and the second-second guide groove surface region may be provided to extend in directions intersecting each other.

In order to achieve the above-mentioned object, another aspect of the present disclosure provides a station including: a station body part; a station base part fixed to one side of the station body part; and a station holder part having a shape protruding upward from an upper surface of the station base part, in which an assembling part seating region is formed on the station base part and has a shape recessed inward in a horizontal direction, in which the station holder part protrudes upward from an upper surface of a portion of the station base part where the assembling part seating region is formed, in which a horizontal cross-sectional shape of the station holder part corresponds to a horizontal cross-sectional shape of the assembling part seating region, and in which an inner surface of the station holder part includes: a first holder part surface region having a shape curved in a direction intersecting an upward/downward direction; and second holder part surface regions each connected to one side end of the first holder part surface region and having a curvature different from a curvature of the first holder part surface region.

An inner portion of a cross-sectional shape, which is made by cutting the second holder part surface region in the direction intersecting the upward/downward direction, may have a line segment shape.

The second holder part surface regions may include a second-first holder part surface region and a second-second holder part surface region provided to be spaced apart from each other in a circumferential direction with the first holder part surface region interposed therebetween.

The second-first holder part surface region and the second-second holder part surface region may be provided in parallel with each other.

The first holder part surface region may include a protruding pressing portion provided on an inner surface of the first holder part surface region and having a shape protruding inward.

A distance between the protruding pressing portion and the second-first holder part surface region may be substantially equal to a distance between the protruding pressing portion and the second-second holder part surface region.

The station base part may include: movement block members provided in an inner surface of the assembling part seating region and configured to be movable in a direction toward a space defined by the assembling part seating region and a direction away from the space; and pressing springs each provided at one side of the movement block member and configured to press the movement block members toward the space defined by the assembling part seating region.

The movement block members may include a first movement block member and a second movement block member provided to face each other with the space, which is defined by the assembling part seating region, interposed therebetween, and the pressing springs may include a first pressing spring and a second pressing spring configured to press the first movement block member and the second movement block member.

The station base part may include: a main base body; an auxiliary base body provided to be spaced apart from the base body; and an elastic connection body configured to connect the main base body and the auxiliary base body, the assembling part seating region may be formed on the auxiliary base body, and the movement block member may be coupled to the auxiliary base body.

A surface of the first movement block member, which is directed toward the space defined by the assembling part seating region, and a surface of the second movement block member, which is directed toward the space defined by the assembling part seating region, may be formed in parallel with each other.

According to the present disclosure, it is possible to provide the structure for connecting the robot arm and the gripper, the structure being capable of adopting various types of connector structures that can be easily mounted and detached in comparison with the related art, and provide the station capable of easily coupling and uncoupling the connection structure.

The present disclosure has been described with reference to the limited examples and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. An assembly structure comprising:
an assembling part; and
a coupling part configured to be attachable to or detachable from the assembling part,
wherein the assembling part comprises:
a body comprising a first side that forms a first opening; and
a flange fixedly coupled to a first side of the body,
wherein the coupling part comprises:
a base; and
a sleeve configured to surround a periphery of the base and comprising a second side that forms a second opening,
wherein the flange is configured to penetrate the sleeve, in a direction facing the base, such that a rotational mobility, about a rotation center axis of the assembly structure, of the flange is restricted relative to a rotational mobility of the base about the rotation center axis,
wherein the sleeve is configured to be rotatable relative to the base,
wherein the sleeve and the flange are configured to, based on a rotation angle of the sleeve with respect to the base being within a predetermined range, interfere with each other in an longitudinal direction parallel to the rotation center axis, and
wherein an outer surface of the sleeve, in a radial direction perpendicular to the rotation center axis, comprises:
a first sleeve surface region having a first curvature relative to the rotation center axis; and
a second sleeve surface region connected to the first sleeve surface region in a circumferential direction around the rotation center axis and having a second curvature, relative to the rotation center axis, different from the first curvature.

2. The assembly structure of claim 1, wherein a cross section of the second sleeve surface region in a direction perpendicular to the rotation center axis comprises a line segment.

3. The assembly structure of claim 2, wherein the second sleeve surface region comprises two second sleeve surface regions spaced apart from each other in the circumferential direction with the first sleeve surface region interposed therebetween.

4. The assembly structure of claim 3, wherein the two second sleeve surface regions are parallel with each other.

5. The assembly structure of claim 1, wherein the base comprises:
a base flange; and
a base protrusion protruding from the base flange,
wherein the base protrusion comprises an outer peripheral surface comprising an interference region protruding radially outward,
wherein the sleeve comprises a first sleeve positioned in the longitudinal direction away from the second opening and around the outer peripheral surface of the base protrusion,
wherein the first sleeve comprises an inner peripheral surface that forms a rotation interference groove configured to accommodate the interference region,
wherein the interference region is configured to interfere with the first sleeve at a boundary, in the circumferential direction, of the rotation interference groove, and
wherein the coupling part further comprises an elastic insert accommodated in the rotation interference groove and extending in the circumferential direction.

6. The assembly structure of claim 5, wherein the outer peripheral surface of the base protrusion comprises a recessed region that is:
recessed inward from the outer peripheral surface, and
spaced apart from the interference region in the circumferential direction,
wherein the coupling part further comprises a latch rotatably coupled to the first sleeve and comprising at least a partial region configured to be, if the sleeve is coupled to the base such that the interference region is inserted in the rotation interference groove, inserted into the recessed region,
wherein a first side end of the elastic insert faces one side boundary, in the circumferential direction, of the rotation interference groove, and
wherein a second side end of the elastic insert faces the interference region.

7. The assembly structure of claim 1, wherein the body comprises an outer surface that forms a guide groove extending in the circumferential direction and recessed radially inward, and
wherein an outer surface of the guide groove comprises:
a first guide groove region having a third curvature relative to the rotation center axis; and
a second guide groove region connected to the first guide groove region in the circumferential direction and having a fourth curvature different from the third curvature.

8. The assembly structure of claim 7, wherein a cross-section of the second guide groove region in a direction perpendicular to the rotation center axis comprises a line segment shape.

9. The assembly structure of claim 8, wherein the second guide groove region comprises two second guide groove regions spaced apart from each other in the circumferential direction with the first guide groove region interposed therebetween.

10. The assembly structure of claim 9, wherein the two second guide groove regions extend in directions intersecting each other.

11. A station comprising:
a station body;
a station base fixed to a first side of the station body; and
a station holder that protrudes, in a first direction away from the station body, from a surface of the station base, wherein the station base comprises an assembling part seating region that is recessed in a second direction perpendicular from the first direction, wherein the station holder protrudes upward from a portion of the surface of the station base that corresponds to the assembling part seating region, and wherein the station holder comprises an inner surface comprising:
a first holder surface region having a first curvature relative to the first direction; and
a second holder surface region connected to the first holder surface region in a circumferential direction around the first direction and having a second curvature different from the first curvature.

12. The station of claim 11, wherein a cross-section, perpendicular to the first direction, of the second holder surface region comprises a line segment shape.

13. The station of claim 12, wherein the second holder surface region comprises two second holder surface regions spaced apart from each other in the circumferential direction with the first holder surface region interposed therebetween.

14. The station of claim 13, wherein the two second holder surface regions are parallel to each other.

15. The station of claim 13, wherein the first holder surface region comprises a protrusion from an inner surface of the first holder surface region.

16. The station of claim 15, wherein the protrusion is substantially equidistance between the two second holder surface regions.

17. The station of claim 11, wherein the station base comprises:
movement blocks provided in an inner surface of the assembling part seating region and configured to be movable toward and away from a space defined by the assembling part seating region; and
pressing springs, provided at sides of the movement blocks, configured to press the movement blocks toward the space.

18. The station of claim 17, wherein the movement blocks comprise a first movement block and a second movement block that face each other with the space interposed therebetween, and
wherein the pressing springs comprise a first pressing spring configured to press the first movement block and a second pressing spring configured to press the second movement block.

19. The station of claim 17, wherein the station base comprises:
a main base body;
an auxiliary base body spaced apart from the base body; and
an elastic connection body configured to connect the main base body and the auxiliary base body,
wherein the auxiliary base body comprises the assembling part seating region, and
wherein the movement blocks are coupled to the auxiliary base body.

20. The station of claim 18, wherein a first surface, of the first movement block, directed toward the space, and a second surface, of the second movement block, directed toward the space, are parallel with each other.
